(19) United States
(12) Patent Application Publication
(10) Pub. No.: US 2012/0132030 A1
(43) Pub. Date: May 31, 2012

(54) BICYCLE PEDAL

(75) Inventor: Kenji KAMADA, Osaka (JP)

(73) Assignee: SHIMANO INC., Osaka (JP)

(21) Appl. No.: 12/954,962

(22) Filed: Nov. 29, 2010

(51) Int. Cl. B62M 3/08

(52) U.S. Cl. 74/594.6

(57) ABSTRACT

A bicycle pedal is provided with a pedal spindle, a pedal body, a first cleat engagement member, a second cleat engagement member and a pivot structure. The pedal body is rotatably mounted on the pedal spindle. The first cleat engagement member is disposed on the pedal body at a first location. The second cleat engagement member is disposed on the pedal body at a second location that is spaced from the first location. At least one of the first and second cleat engagement members is movably mounted relative to the pedal body between a release position and an engagement position. The pivot structure is disposed on the pedal body at a third location that is disposed between the first and second locations of the first and second cleat engagement members.

### BACKGROUND

1. Field of the Invention

This invention generally relates to a bicycle pedal. More specifically, the present invention relates to a step-in or clipless type of bicycle pedal that engages a cleat in a releasable manner.

2. Background Information

In recent years, step-in or clipless pedals have been gaining more popularity. The step-in or clipless pedal releasably engages a cleat that is secured to the sole of a rider's shoe. In other words, cleats are attached to the soles of specially-designed cycling shoes. The cleats lock the rider's feet into the pedals. The step-in pedal typically has at least one cleat engagement mechanism. The cleat engagement mechanism clamps onto a cleat that is attached to the soles of a cycling shoe. In using step-in pedals, the rider steps onto one side of the pedal and the cleat engagement mechanism automatically grips on to the cleat that is secured to the bottom sole of the rider's shoe. When releasing the shoe from most types of step-in pedals, the rider will typically turn the shoe about an axis perpendicular or approximately perpendicular to the tread of the rider's shoe, using the front end of the cleat as a pivoting point. As a result of this pivoting action, the rear cleat engagement member is moved to release the cleat and the shoe from the pedal. One example of a step-in pedal that operates in the above mentioned manner is disclosed in U.S. Pat. No. 6.845,688. With this pedal, there are two types of cleats. A first type of cleat has a wide front tip that tightly fits to the pedal to prevent lateral (sideways) sliding of the cleat on the pedal along the axial direction of the pedal spindle with the cleat firmly engaged with the pedal. A second type of cleat has a narrow front tip that is allows lateral (sideways) sliding of the cleat on the pedal along the axial direction of the pedal spindle. The rider can choose between the two types of cleats depending on the rider's riding style, the rider's abilities and/or the rider's arthral characteristic of knee. When the rider is pedaling hard, the second type of cleat slides to the outside or inside direction depending on the circumstances. This sliding of the cleat causes a decrease in the efficiency of pedal input and/or may cause an uncomfortable feeling to the rider.

### SUMMARY

One object of the present invention is to provide a bicycle pedal that prevents lateral (sideways) sliding of a cleat on its pedal body in the axial direction of the pedal spindle with the cleat firmly engaged with the pedal body.

The foregoing object can basically be attained by providing a bicycle pedal that basically comprises a pedal spindle, a pedal body, a first cleat engagement member, a second cleat engagement member and a pivot structure. The pedal body is rotatably mounted on the pedal spindle. The first cleat engagement member is disposed on the pedal body at a first location. The second cleat engagement member is disposed on the pedal body at a second location that is spaced from the first location. At least one of the first and second cleat engagement members is movably mounted relative to the pedal body between a release position and an engagement position. The pivot structure is disposed on the pedal body at a third location that is disposed between the first and second locations of the first and second cleat engagement members.

These and other objects, features, aspects and advantages of the present invention will become apparent to those skilled in the art from the following detailed description, which, taken in conjunction with the annexed drawings, discloses preferred embodiments.

### BRIEF DESCRIPTION OF THE DRAWINGS

Referring now to the attached drawings which form a part of this original disclosure:

FIG. 1 is an outside elevational view of a bicycle pedal system that includes a bicycle pedal and a cleat in accordance with a first illustrated embodiment;

FIG. 2 is a top perspective view of the bicycle pedal illustrated in FIG. 1, with the cleat attached thereto;

FIG. 3 is a top perspective view of the bicycle pedal illustrated in FIG. 1, with the cleat removed;

FIG. 4 is a top plan view of the bicycle pedal illustrated in FIGS. 1 to 3, with the cleat removed;

FIG. 5 is a top plan view of the cleat engaged with the bicycle pedal illustrated in FIGS. 1 to 4, with the cleat in a center cleat position;

FIG. 6 is a top plan view of the cleat engaged with the bicycle pedal illustrated in FIGS. 1 to 5, but with the cleat pivoted from the center cleat position to a twisted or pivoted cleat position in which the rear cleat engagement member is in the full engagement position;

FIG. 7 is a top plan view of the cleat engaged with the bicycle pedal illustrated in FIGS. 1 to 6, but with the cleat pivoted from the center cleat position to a cleat release position in which the rear cleat engagement member has been pivoted from the full engagement position to the release position;

FIG. 8 is a cross sectional view of a portion of the bicycle pedal and the cleat illustrated in FIGS. 1, 2, 5, 6 and 7 as seen along section line 8-8 of FIG. 5;

FIG. 9 is an enlarged cross sectional view of a portion of the bicycle pedal and the cleat illustrated in FIGS. 1, 2, 5, 6 and 7 as seen along section line 9-9 of FIG. 8;

FIG. 10 is an exploded perspective view of the bicycle pedal illustrated in FIGS. 1 to 8;

FIG. 11 is an exploded perspective view of the cleat assembly for attaching the cleat to the bicycle shoe illustrated in FIG. 1;

FIG. 12 is a top plan view of the cleat illustrated in FIGS. 1, 2, 5 to 8 and 11 in accordance with the illustrated embodiment;

FIG. 13 is a side elevational view of the cleat illustrated in FIG. 12 in accordance with the illustrated embodiment;

FIG. 14 is a front elevational view of the cleat illustrated in FIGS. 12 and 13 in accordance with the illustrated embodiment;

FIG. 15 is a rear elevational view of the cleat illustrated in FIGS. 12 to 14 in accordance with the illustrated embodiment;

FIG. 16 is a top plan view of a first variation of the bicycle pedal illustrated in FIGS. 1 to 8, in which the pivot structure is located rearward of the spindle axis;

FIG. 17 is a top plan view of a second variation of the bicycle pedal illustrated in FIGS. 1 to 8, in which the pivot structure is located forward of the spindle axis;

FIG. 18 is a top perspective view of a bicycle pedal illustrated in accordance with a second illustrated embodiment, with the cleat illustrated in FIGS. 12 to 15 attached thereto;

FIG. 19 is a top perspective view of the bicycle pedal illustrated in FIG. 18, with the cleat removed;

FIG. 20 is a top plan view of the bicycle pedal illustrated in FIGS. 18 and 19, with the cleat in a center cleat position;

FIG. 21 is a top plan view of the cleat engaged with the bicycle pedal illustrated in FIGS. 18 to 20, but with the cleat pivoted from the center cleat position to a twisted or pivoted cleat position in which the rear cleat engagement member is in the full engagement position;

FIG. 22 is a top plan view of the cleat engaged with the bicycle pedal illustrated in FIGS. 18 to 21, but with the cleat pivoted from the center cleat position to a cleat release position in which the rear cleat engagement member has been pivoted from the full engagement position to the release position;

FIG. 23 is a cross sectional view of a portion of the bicycle pedal and the cleat illustrated in FIGS. 18 to 22 as seen along section line 23-23 of FIG. 20;

FIG. 24 is a cross sectional view of a first alternate configuration of the mating pivot structures of the bicycle pedal and the cleat for the first and/or second embodiments;

FIG. 25 is an enlarged cross sectional view of the first alternate configuration of the mating pivot structures of the bicycle pedal and the cleat as seen along section line 25-25 of FIG. 24;

FIG. 26 is an enlarged cross sectional view of a second alternate configuration of the mating pivot structures of the bicycle pedal and the cleat for the first and/or second embodiments;

FIG. 27 is an enlarged cross sectional view of the second alternate configuration of the mating pivot structures of the bicycle pedal and the cleat as seen along section line 27-27 of FIG. 26;

FIG. 28 is an enlarged cross sectional view of a third alternate configuration of the mating pivot structures of the bicycle pedal and the cleat for the first and/or second embodiments; and

FIG. 29 is an enlarged cross sectional view of a fourth alternate configuration of the mating pivot structures of the bicycle pedal and the cleat for the first and/or second embodiments.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

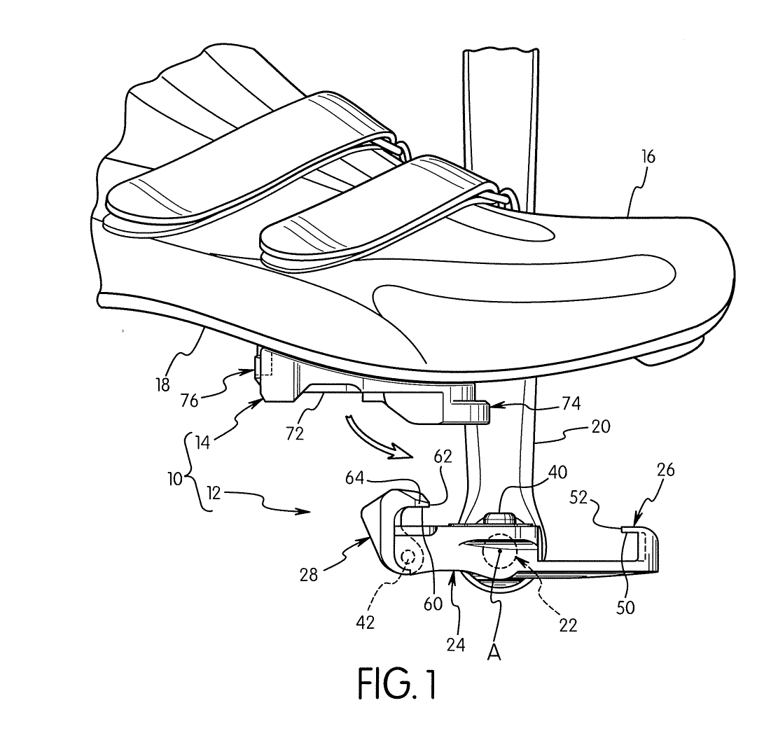

Referring initially to FIGS. 1 to 5, a bicycle pedal assembly 10 is illustrated that includes a bicycle pedal 12 and a cleat 14 in accordance with a first illustrated embodiment. The bicycle pedal assembly 10 is a clipless or step-in pedal assembly. In other words, the bicycle pedal 12 is a clipless or step-in pedal that is used with a bicycle shoe 16 having the cleat 14 fixedly coupled to a sole 18 of the shoe 12. As seen in FIG. 1, the bicycle pedal 12 is fixedly coupled to a bicycle crank arm 20 of a bicycle and the cleat 14 is fixedly coupled to the sole 18 of the shoe 16.

The bicycle pedal assembly 10 is especially designed for use with road bicycles as opposed to use with an off-road bicycle. However, it will be apparent to those skilled in the art from this disclosure that the features of the bicycle pedal assembly 10 can be used in the construction of an off-road type of bicycle pedal assembly if needed and/or desired. In other words, it will be apparent from this disclosure that the bicycle pedal 12 can be redesigned with a cleat retaining structure disposed on opposite sides of the bicycle pedal 12.

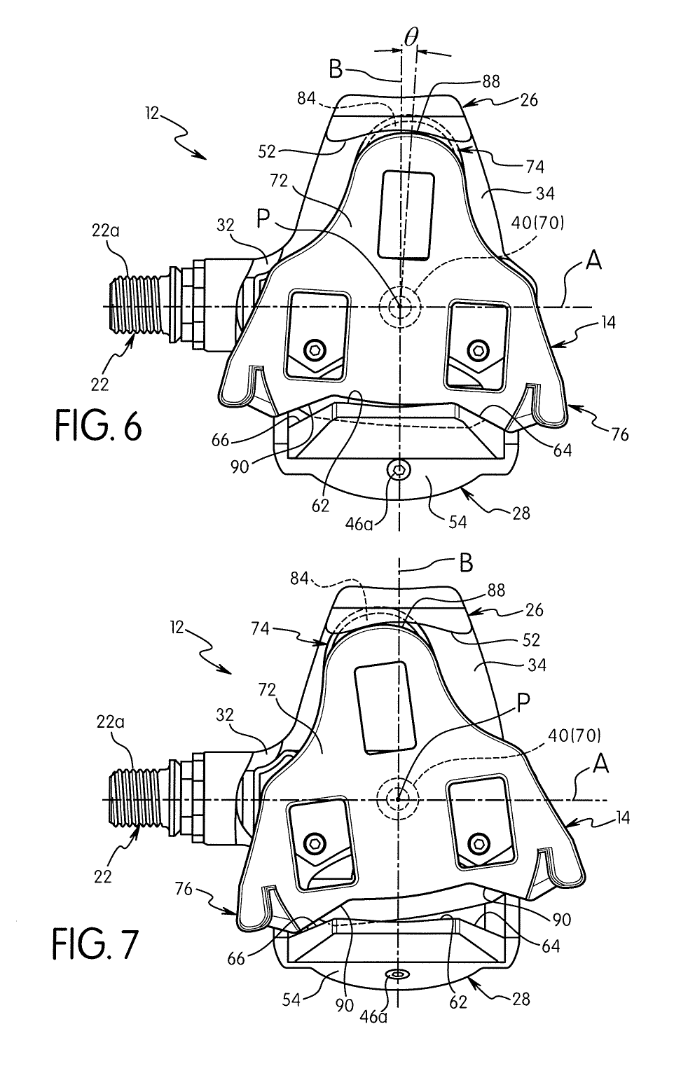

As seen in FIGS. 5 to 7, the cleat 14 is selectively coupled to the bicycle pedal 12 in a releasable manner. The bicycle pedal 12 and the cleat 14 are configured and arranged with respect to each other such that the cleat 14 can only pivot relative to the bicycle pedal 12 while the cleat 14 is retained on the bicycle pedal 12. When the cleat 14 is coupled to the bicycle pedal 12, the cleat 14 has a cleat pivot axis P, as seen in FIGS. 5 to 7, around which the cleat 14 pivots relative to the bicycle pedal 12. The cleat pivot axis P is a fixed (non-movable) axis that does not change. In the illustrated embodiment, the bicycle pedal 12 is configured and arranged to limit pivotally movement of the cleat 14 on the bicycle pedal 12 within a predetermined angle θ (e.g., three and one-half degrees in the illustrated embodiment) in each direction from a center cleat position (FIG. 5) about the fixed pivot axis P as seen in FIG. 6. Once the cleat 14 pivots through the predetermined angle θ (e.g., three and one-half degrees) about the cleat pivot axis P on the bicycle pedal 12, any further pivotally movement of the cleat 14 about the cleat pivot axis P causes a releasing action to begin as discussed below.

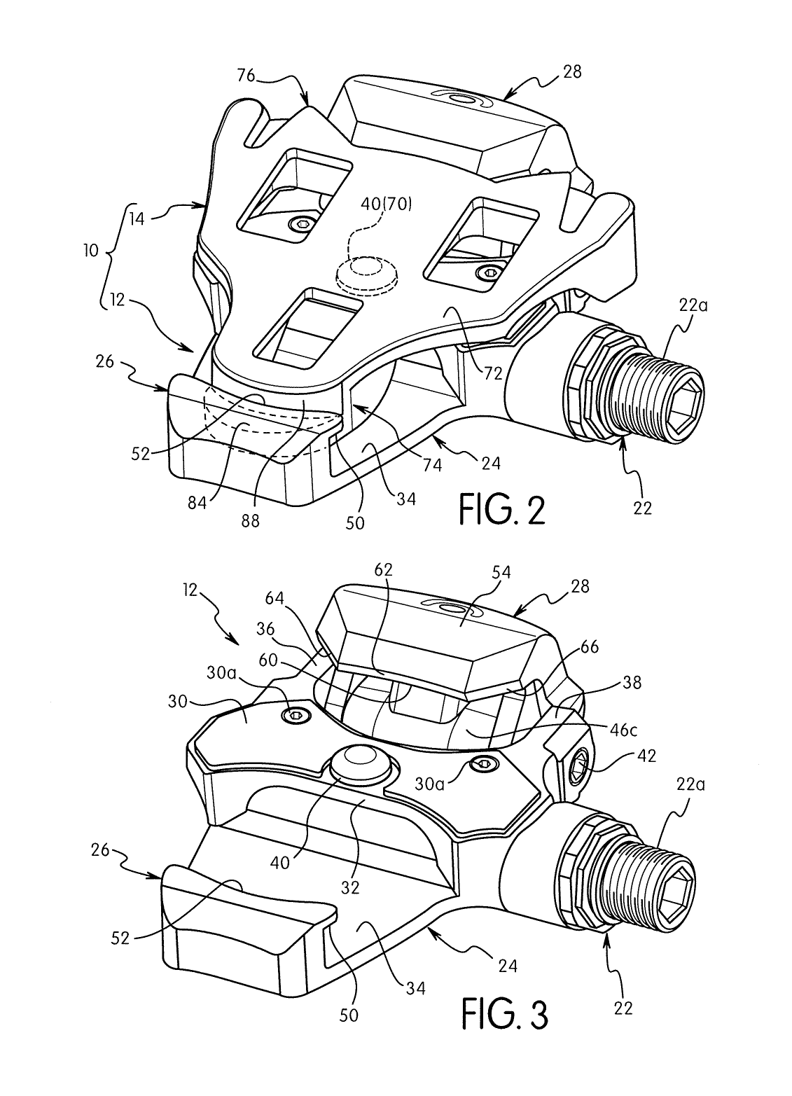

As seen in FIGS. 2-8, the bicycle pedal 12 basically includes a pedal shaft or spindle 22, a pedal body 24, a front (first) cleat engagement member 26 and a rear (second) cleat engagement member 28. The front cleat engagement member 26 is non-movably coupled to the pedal body 24, while the rear cleat engagement member 28 is movably coupled to the pedal body 24. The rear cleat engagement member 28 is pivotally coupled to the pedal body 24 in this embodiment. The front and rear cleat engagement members 26 and 28 define a cleat retaining structure that is coupled to an upper surface of the pedal body 24. A cleat receiving area is formed on one side of the pedal body 24 for receiving and retaining the cleat 14 thereon. More specifically, the cleat receiving area is defined as the space located between the front and rear cleat engagement members 26 and 28.

In FIGS. 1 to 10, the bicycle pedal 12 is a right side bicycle pedal. A left side bicycle pedal (not shown) is a mirror image of the right side bicycle pedal 12, except that the pedal spindle 22 of the right-side (usually the drive-side) has a right-hand thread, while the pedal spindle of the left-side (usually the non-drive-side) has a left-hand (reverse) thread to help prevent the pedals from becoming loose. For the sake of simplicity, only the bicycle pedal 12, which is a right side bicycle pedal, will be illustrated and described herein. Of course, the description of the bicycle pedal 12 applies to a left-side bicycle pedal.

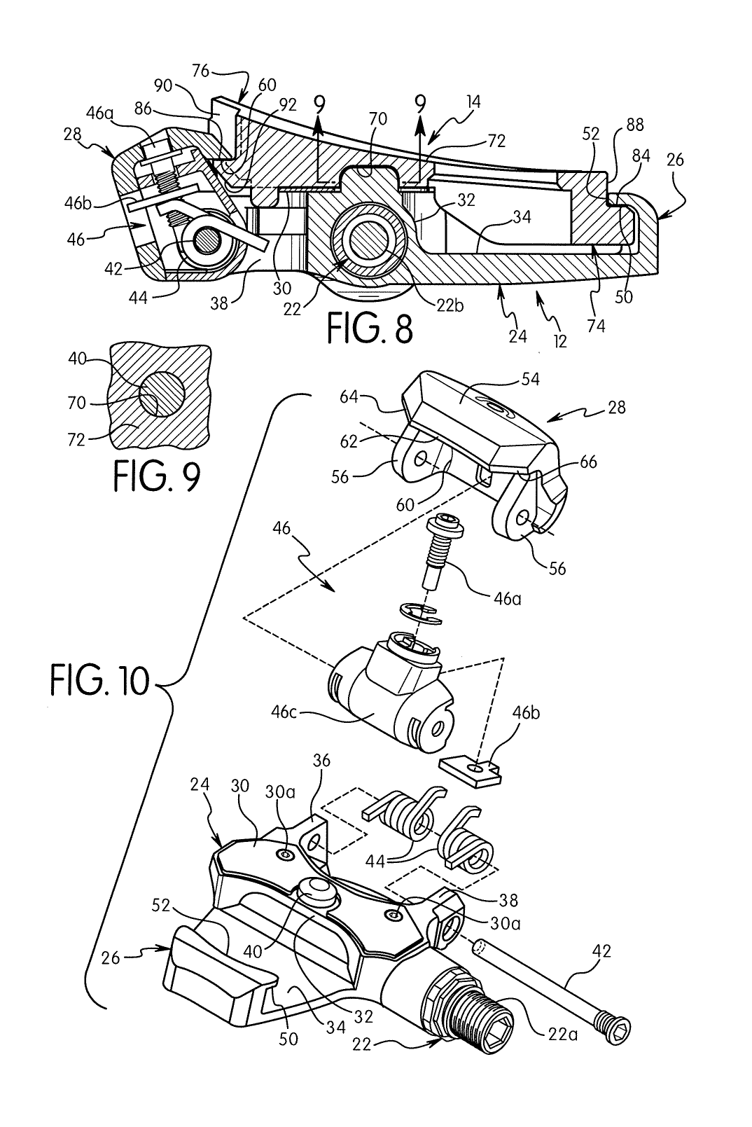

The spindle 22 is adapted to be coupled to the crank arm 20, while the pedal body 24 is rotatably coupled to the pedal spindle 22 for supporting a rider's foot. Specifically, the pedal spindle 22 has a first end 22a with a thread that is fastened to the crank arm 20 and a second end 22b (FIG. 8) that rotatably supports the pedal body 24 by a conventional bearing assembly (not shown). The spindle 22 has a spindle axis A that extends between the first and second ends 22a and 22b of the pedal spindle 22. The pedal body 24 is freely rotatable about the spindle axis A. Typically, the pedal spindle 22 is secured to the pedal body 24 by an inner tube and a lock nut in a conventional manner. More specifically, the pedal spindle 22 has the lock nut mounted thereon to secure a bearing assembly and the pedal spindle 22 within the hollow area of the pedal body 24. Since these parts are relatively conventional parts and the specific constructions of these parts are not critical to the present embodiment, they will not be discussed or illustrated in detail herein. Rather, these parts will only be discussed as necessary to understand the present embodiment.

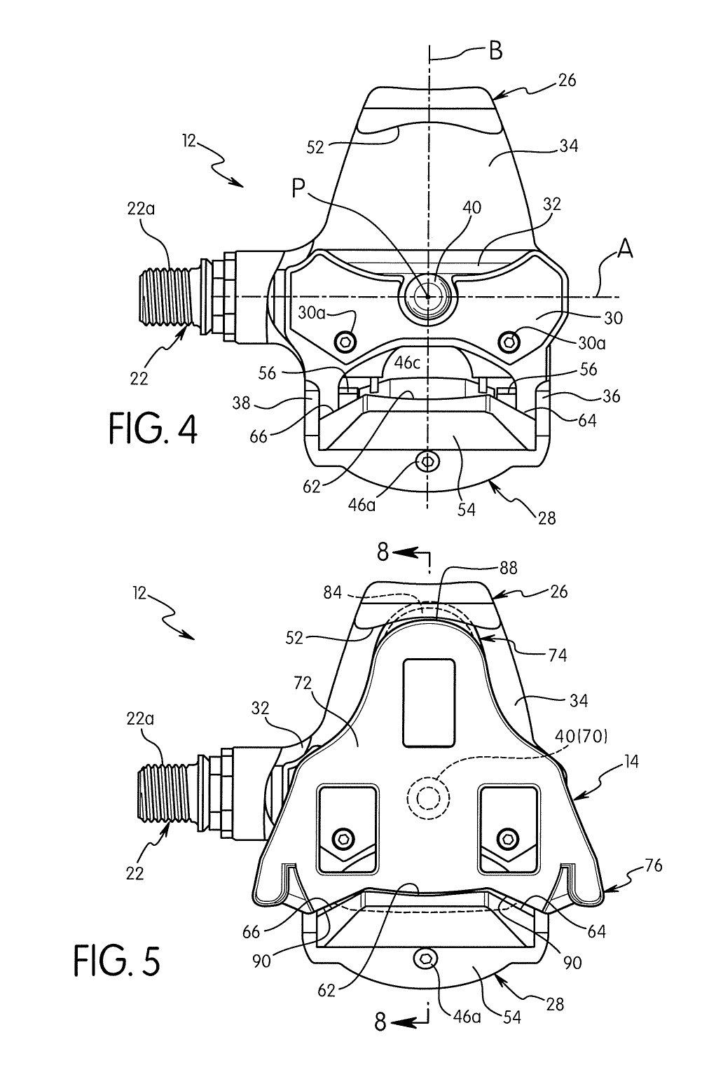

Referring to FIGS. 4, 8 and 10, the pedal body 24 is a rigid member that is made of a suitable lightweight material, such as aluminum alloy, a synthetic resin, or a fiber reinforced plastic. The pedal body 24 is designed to support a rider's foot by a releasable connection between the cleat 14 and the front and rear cleat engagement members 26 and 28. As mentioned above, the front cleat engagement member 26 is fixedly and rigidly coupled at the front end of the pedal body 24, while the rear cleat engagement member 28 is pivotally coupled to the rear end of the pedal body 24.

Optionally, a pad 30 can be added that overlies a center upper portion of the pedal body 24 along portions of the center tubular shaft support portion 32. The pad 30 is preferably fixedly secured in a recess formed in the pedal body 24 by a pair of fasteners 30a. Since the pad 30 is optional, it will not be discussed or illustrated herein.

In the illustrated embodiment, the pedal body 24 includes a tubular shaft support portion 32, a forward portion 34 and a pair of rear portions 36 and 38. The tubular shaft support portion 32 is preferably integrally formed with the forward portion 34 and the rear portions 36 and 38 as a one-piece, unitary member. Of course, it will be apparent to those skilled in the art from this disclosure that other constructions could be utilized if needed and/or desired. For example, the pedal body could be formed of several separate pieces removably secured together by a plurality of screws or other conventional fasteners.

A pivot structure 40 is disposed on the pedal body 24 at a third location that is disposed between the first and second locations of the front and rear cleat engagement members 26 and 28. Thus, in this first embodiment, the front and rear cleat engagement members 26 and 28 are longitudinally spaced from the third location with respect to a longitudinal axis B of the pedal body 24 that is transverse to the pedal spindle axis A. The front and rear cleat engagement members 26 and 28 are configured and arranged with respect to each other and the pivot structure 40 to limit pivotally movement of the cleat 14 that is retained on the pedal body 24. The pivot structure 40 is configured and arranged to cooperate with the cleat 14 to prevent lateral and/or longitudinal movement of the cleat 14 that is retained on the pedal body 24. In other words, in this first embodiment, the pivot structure 40 of the pedal body 24 cooperates with cleat 14 such that the cleat 14 can only pivot (i.e., no lateral movement and/or no longitudinal movement) with respect to the pedal body 24 so long as the cleat 14 retained on the pedal body 24 by the front and rear cleat engagement members 26 and 28 in their full cleat engagement position.

In this first embodiment, the pivot structure 40 includes a single projection. For example, the shape of the pivot structure 40 is a half hemisphere or column. However, the pivot structure 40 can have a variety of shapes as needed and/or desired. The third location of the pivot structure 40 is disposed at on the tubular shaft support portion 32, which is a part of the pedal body 24 that is adjacent the pedal spindle 22. Since the tubular shaft support portion 32 covers the pedal spindle 22 in this first embodiment, the third location of the pivot structure 40 is disposed on a part (the tubular shaft support portion 32) of the pedal body 24 which covers the pedal spindle 22. Also in this first embodiment, the third location of the pivot structure 40 is disposed at a longitudinal midpoint between the front and rear cleat engagement members 26 and 28, and adjacent a lateral midpoint of the pedal body 24 with respect to a lateral direction of the pedal body 24.

The forward portion 34 extends from the tubular shaft support portion 32 and supports the front cleat engagement member 26 at a first location on the pedal body 24. The forward portion 34 supports the front cleat engagement member 26 from below. In other words, the front cleat engagement member 26 is supported by the forward portion 34 to extend in a vertical direction with respect to the axes A and B while the pedal body 24 is horizontal and the front cleat engagement member 26 is on the upper side of the pedal body 24. The front cleat engagement member 26 is also preferably integrally formed with the pedal body 24. Of course, it will be apparent to those skilled in the art that the front cleat engagement member 26 could be a separate member that is releasably coupled to the pedal body 24 if needed and/or desired. In any event, the front cleat engagement member 26 is preferably fixedly and non-movably coupled to the pedal body 24. However, the front cleat engagement member 26 can be movably coupled to the pedal body 24 if needed and/or desired.

The rear portions 36 and 38 extend from the center tubular shaft support portion 32 and support the rear cleat engagement member 28 at a second location on the pedal body 24 that is longitudinally spaced from the first location of the pedal body 24. A support pin 42 extends between the rear portions 36 and 38 to pivotally support the rear cleat engagement member 28 for movement between the engagement position and the release position. In the illustrated embodiment, the rear cleat engagement member 28 is biased to the engagement position by a pair of torsion springs 44. While the springs 44 are preferably mounted on the support pin 42, it will be apparent to those skilled in the art from this disclosure that fewer or more springs can be used and that they can be mounted is a variety of ways. Moreover, it will be apparent to those skilled in the art the other types of urging member(s) or resilient member(s) could be utilized to carry out the present invention. Accordingly, the term “biasing member” as used herein refers to one or more members that applies an urging force between two elements. Thus, the torsion springs 44 constitute a biasing member that applies an urging force between the pedal body 24 and the rear cleat engagement member 28 to bias the rear cleat engagement member 28 to the engagement position.

As best seen in FIGS. 8 and 10, a tension adjustment mechanism 46 is disposed between the pedal body 24 and the torsion springs 44 for adjusting the tension (i.e., the biasing force) of the torsion springs 44. The tension adjustment mechanism 46 basically includes an adjustment bolt 46a, an adjustment plate 46b and a spring cover 46c. The adjustment bolt 46a is threaded into a threaded hole formed in the adjustment plate 46b. The head of the adjustment bolt 46a has a non smooth indexing surface designed to mate with a surface of the rear cleat engagement member 28. Thus, the adjustment bolt 46a does not become loose due to vibrations and/or wear. The adjustment plate 46b is a T-shaped plate that has a base portion located in the slot of the rear cleat engagement member 28 to prevent rotation of the adjustment plate 46b. The adjustment bolt 46a and the adjustment plate 46b contacts the rear cleat engagement member 28 such that the biasing force of the springs 44 is transferred to the rear cleat engagement member 28. The tension adjustment mechanism 46 is relatively conventional, and thus, will not be discussed and/or illustrated in detail herein. The torsion springs 44 have their mounting or coiled portions mounted on the support pin 42, with one end of each spring 44 engaging a part of the pedal body 24 and the other end of each spring 44 engaging the tension adjustment mechanism 46 (indirectly engaging the rear cleat engagement member 28). The springs 44 normally urge the cleat engagement member 28 to rotate about the support pin 42 from the cleat release position to the cleat engagement position. In other words, the springs 44 normally maintain the cleat engagement member 28 in cleat engagement position.

The front cleat engagement member 26 basically includes a front cleat retention surface 50 and a front cleat abutment surface 52, as seen in FIGS. 8 and 10. The front cleat retention surface 50 is a substantially flat surface that faces in a downward (first) direction when the pedal 12 is in the normal riding position. The front cleat abutment surface 52 is preferably arranged substantially perpendicular to the front cleat retention surface 50. The front cleat abutment surface 52 is formed as a curved surface concave profile.

Referring FIGS. 8 and 10, the rear cleat engagement member 28 has a roughly U-shaped configuration, with its two ends being pivotally supported by the support pin 42. The rear cleat engagement member 28 basically includes a rear clamping portion 54 and a pair of mounting flanges 56. The mounting flanges 56 form a mounting portion of the rear cleat engagement member 28. The mounting flanges 56 extend from the rear clamping portion 54 to mount the rear cleat engagement member 28 on the support pin 42.

The rear clamping portion 54 of the rear cleat engagement member 28 basically includes a rear cleat retention surface 60, a rear cleat abutment surface 62 and a pair of side stop surfaces 64 and 66. The rear cleat retention surface 60 is a flat surface that faces in the same direction (i.e., the first downward direction) as the front cleat retention surface 50. Preferably, the front and rear cleat retention surfaces 50 and 60 are parallel to each other. The rear cleat abutment surface 62 is a transverse surface extending upwardly from the rear cleat retention surface 60. The rear cleat abutment surface 62 is preferably substantially perpendicular to the rear cleat retention surface 60. As best seen in FIG. 4, the rear cleat abutment surface 62 is preferably a continuous curved surface, which is concave and connects with the side stop surfaces 64 and 66. The side stop surfaces 64 and 66 are angled relative to each other to provide space for the floating movements of the cleat 14. The side stop surfaces 64 and 66 also aid in the disengagement of the cleat 14 from the pedal 12. More specifically, when the cleat 14 rotates a predetermined amount, one of the side stop surfaces 64 and 66 acts as an inclined plane to rotate the rear cleat engagement member 28 against the biasing force of the springs 44 to release the cleat 14 from the pedal 12. One of the side surfaces 64 and 66 then acts as slide surface such that the cleat 14 can be completely released from the pedal 12.

During normal engagement between the pedal 12 and the cleat 14, the cleat 14 cannot move along the longitudinal axis B of the pedal body 24 without rotating the rear cleat engagement member 28 against the biasing force of the springs 44. However, the cleat 14 is designed such that the cleat 14 pivots through a predetermined range of pivotal movement without releasing the bicycle shoe cleat 14 from the bicycle pedal 12, but does not move laterally relative to the pedal body 24 until the shoe cleat 14 is released from the bicycle pedal 12. Specifically, when the cleat 14 is coupled to the bicycle pedal 12, the cleat 14 pivots about the cleat pivot axis P by an angle A in each direction from the center position along longitudinal axis B as seen in FIG. 6. In the illustrated embodiment, the pedal 12 and the cleat 14 are configured such that the cleat 14 only pivots around the cleat pivot axis P for about three and one-half degrees in each direction as measured from a center longitudinal axis B that passes through the cleat pivot axis P.

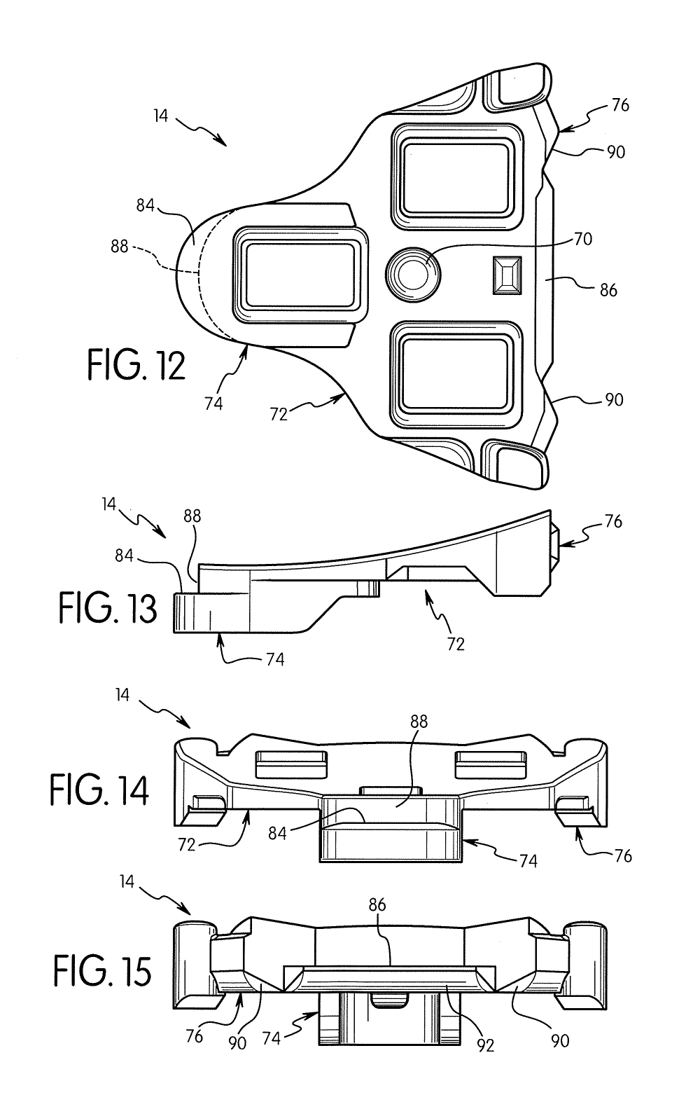

As best seen in FIGS. 12 to 17, the cleat 14 is provided with a pivot structure 70 that is provided at a middle portion 72 of the cleat 14. The pivot structure 70 is configured and arranged to mate with the pivot structure 40 of the pedal body 24. As seen in FIG. 8, the pivot structures 40 and 70 mate such that the cleat 14 is prevented from relative longitudinal movement between the cleat 14 and the pedal body 24 when the front and rear cleat engagement members 26 and 28 are engaged with the front and rear engagement ends 74 and 76, respectively. In other words, the pivot structures 40 and 70 are configured to limit rearward movement of the cleat 14 relative to the pedal body 24 such that the cleat 14 is not inadvertently released from the pedal body 24 due to rearward relative movement of the cleat 14 relative to the pedal body 24. In this first embodiment, the pivot structure 70 includes a single recess. For example, the shape of the pivot structure 70 is a half hemisphere or column. However, the pivot structure 70 can have a variety of shapes as needed and/or desired. In any event, the pivot structure 70 is dimensioned to mate with the pivot structure 40 of the pedal body 24 such that the cleat 14 can only pivot relative to the pedal body 24 while the cleat 14 is retained on the pedal body 24 by the front and rear cleat engagement members 26 and 28 engaging the front and rear cleat engagement ends 74 and 76 of the cleat 14.

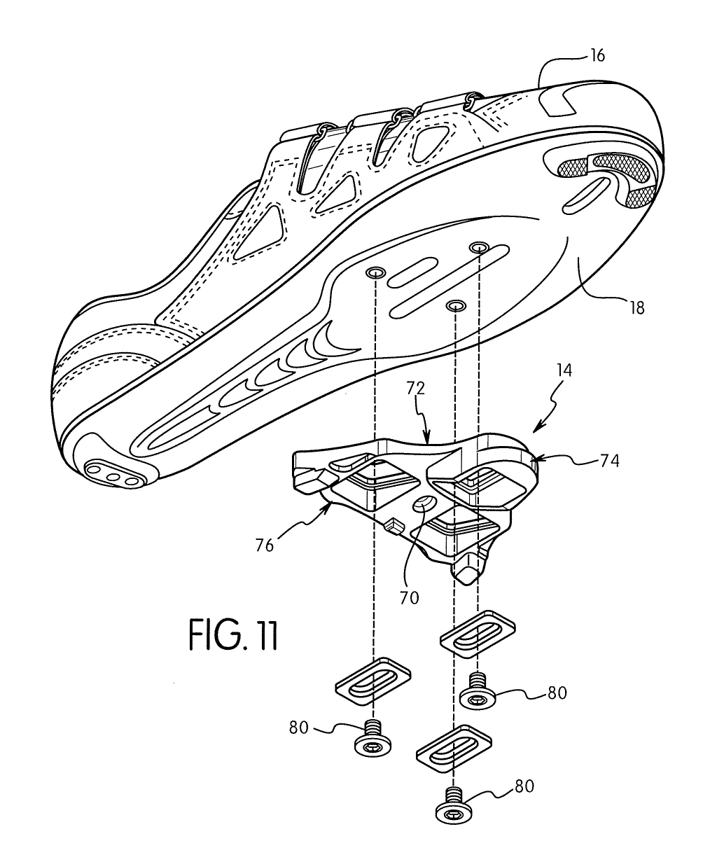

As best seen in FIG. 11, the middle portion 72 has a plurality (three) of holes 78 formed therein for receiving fasteners or fixing bolts 80. Thus, the cleat 14 is fixedly coupled to a bottom surface of the sole 18 of the shoe 12 by the fixing bolts 80. However, the cleat fastening arrangement for the cleat 14 can be any type of fastening arrangement, and thus, the cleat fastening arrangement will not be discussed in detail herein. The middle portion 72 has an upper sole side facing in a first direction for engaging the sole of the shoe 16 and a lower (bottom) pedal side facing in a second direction which is substantially opposite to the first direction.

The cleat 14 also includes a first or front engagement end 74 extending from one end of the middle portion 72 and a second or rear engagement end 76 extending from the other end of the middle portion 72. Thus, the rear engagement end 76 is longitudinally spaced from the front engagement end 74 with the middle portion 72 being disposed between the front and rear cleat engagement ends 74 and 76. Preferably, the middle portion 72 and the front and rear cleat engagement ends 74 and 76 are integrally formed together as a one-piece, unitary member, which is constructed from a suitable rigid material.

As seen in FIGS. 12 to 15, the front engagement end 74 of the cleat 14 includes a front pedal contact surface 84 is selectively engaged with the front cleat retention surface 50 of the front cleat engagement member 26. The rear engagement end 76 of the cleat 14 includes a rear pedal contact surface 86 is selectively engaged with the rear cleat retention surface 60 of the rear cleat engagement member 28. The front engagement end 74 of the cleat 14 also includes a front stop surface 88 that extends substantially perpendicular to the front pedal contact surface 84. Similarly, the rear engagement end 76 of the cleat 14 also includes a pair of rear stop surfaces 90 that extends substantially perpendicular to the rear pedal contact surface 86. Either the front stop surface 88 or the rear stop surfaces 90 of the cleat 14 can be configured and arranged to limit the pivotally movement of the cleat 14 relative to the pedal body 24. In the illustrated embodiment, one of the rear stop surfaces 90 contacts one of the stop surfaces 64 and 66 to limit the pivotally movement of the cleat 14 relative to the pedal body 24. As best seen in FIG. 15, the rear engagement end 76 of the cleat 14 also includes a curved bottom edge surface 92 for contacting the clamping portion 54 of the rear cleat engagement member 28 to cause the rear cleat engagement member 28 to pivot on the support pin 42 against the biasing force of the torsion springs 44 during a step-in operation.

During a step-in operation to retain the shoe 16 on the pedal 12, the rider presses the cleat 14 into the pedal 12 with a forward and downward motion in a conventional manner. In particular, the cleat 14 is engaged with the pedal 12 by first engaging the front engagement end 74 of the cleat 14 with the front cleat engagement member 26 so that front pedal contact surface 84 of the cleat 14 is beneath the front cleat retention surface 50 of the front cleat engagement member 26. Next, the rider presses the curved bottom edge surface 92 of the rear engagement end 76 of the cleat 14 onto the rear clamping portion 54 of the rear cleat engagement member 28. This downward pressure of the cleat 14 onto the rear clamping portion 54 of the rear cleat engagement member 28 causes the rear cleat engagement member 28 to pivot on the support pin 42 against the biasing force of the torsion springs 44. After the curved bottom edge surface 92 passes over the rear clamping portion 54 of the rear cleat engagement member 28, the rear cleat engagement member 28 pivots back to the cleat engagement position on the support pin 42 due to the biasing force of the torsion springs 44. Now, the rear pedal contact surface 86 engages the rear cleat retention surface 56 of the rear cleat engagement member 28 to releasbly locks the cleat 14 to the pedal 12.

During a step-out operation to release the shoe 16 from the pedal 12, the rider twists the shoe 16 to the outside of the pedal 12 so that the cleat 14 pivots on the cleat pivot axis P to move the rear cleat engagement member 28 rearward from the cleat engagement position to the cleat release position. However, as mentioned above the shoe 16 is also capable of a limited amount of rotation about the cleat pivot axis P prior to disengagement. Once the cleat 14 has rotated sufficiently, the rear cleat engagement member 28 will being to pivot back to the cleat engagement position (the normal rest position) on the support pin 42 due to the biasing force of the torsion springs 44.

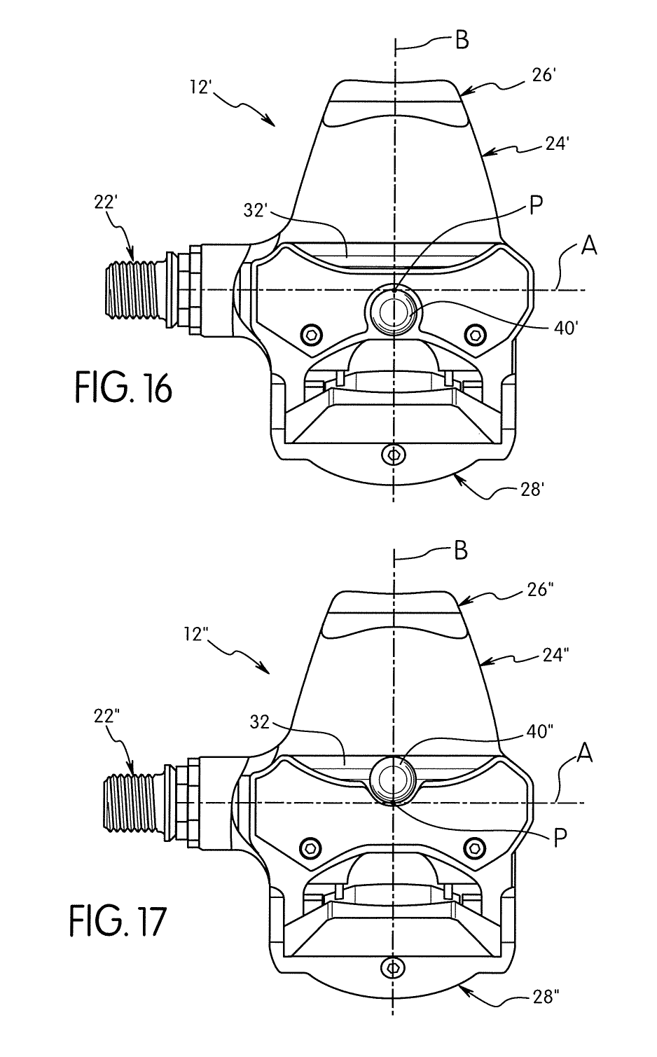

Referring to FIG. 16, a top plan view of a bicycle pedal 12′ is illustrated. The bicycle pedal 12′ is a first variation of the bicycle pedal 12 illustrated in FIGS. 1 to 8. The bicycle pedal 12′ has a spindle 22′ and a modified pedal body 24′. The pedal body 24′ includes a front cleat engagement member 26′, a rear cleat engagement member 28′ and a center tubular shaft support portion 32′ that has a pivot structure 40′. The pivot structure 40′ is disposed at a location rearward of the spindle axis A of the spindle 22′. The bicycle pedals 12 and 12′ are identical, except that the bicycle pedal 12′ has a modified pedal body 24′ with the pivot structure 40′ being disposed at a location, which is between the rear cleat engagement member 28′ and a longitudinal midpoint between the front and rear cleat engagement members 26′ and 28′. Here, the longitudinal midpoint of the pedal body 24′ corresponds to the spindle axis A. In view of the similarities between the bicycle pedals 12 and 12′, the bicycle pedal 12′ will not be discussed in detail herein. The bicycle pedal 12′ is used with a modified version of the cleat 14. In particular, the cleat used with the bicycle pedal 12′ is used identical to the cleat 14, except that the location of the pivot structure 70 has been moved to correspond to the location of the pivot structure 40′ of the pedal body 24′ so that they can mate together.

Referring to FIG. 17, a top plan view of a bicycle pedal 12″ is illustrated. The bicycle pedal 12″ is a second variation of the bicycle pedal 10 illustrated in FIGS. 1 to 8. The bicycle pedal 12″ has a spindle 22″ and a modified pedal body 24″. The pedal body 24″ includes a front cleat engagement member 26″, a rear cleat engagement member 28″ and a center tubular shaft support portion 32″ that has a pivot structure 40′. The pivot structure 40″ is disposed at a location forward of the spindle axis A. The bicycle pedals 12 and 12″ are identical, except that the bicycle pedal 12″ has a modified pedal body 24″ with the pivot structure 40″ being disposed at a location, which is between the front cleat engagement member 26″ and a longitudinal midpoint between the front and rear cleat engagement members 26″ and 28″. Here, the longitudinal midpoint of the pedal body 12″ corresponds to the spindle axis A. In view of the similarities between the bicycle pedals 12 and 12″, the bicycle pedal 12″ will not be discussed in detail herein. The bicycle pedal 12″ is used with a modified version of the cleat 14. In particular, the cleat used with the bicycle pedal 12″ is used identical to the cleat 14, except that the location of the pivot structure 70 has been moved to correspond to the location of the pivot structure 40″ of the pedal body 24″ so that they can mate together.

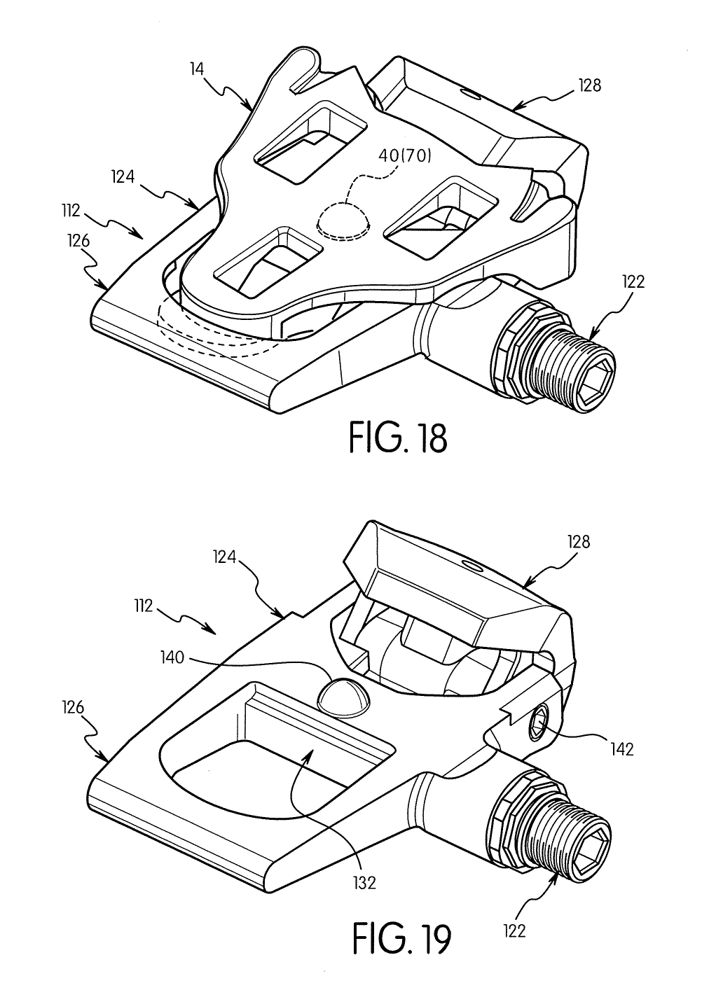

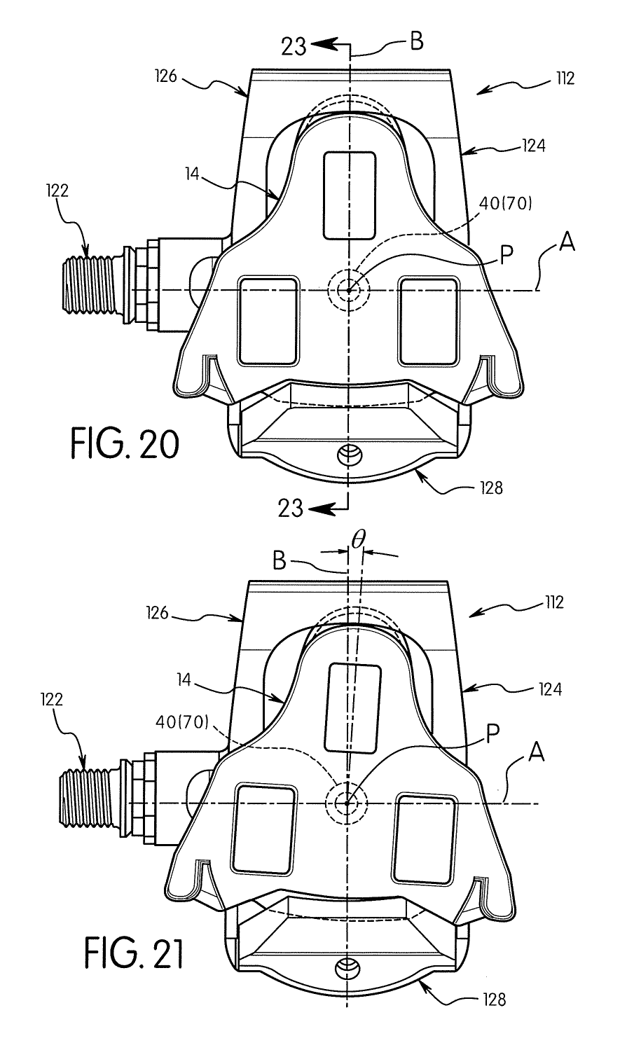

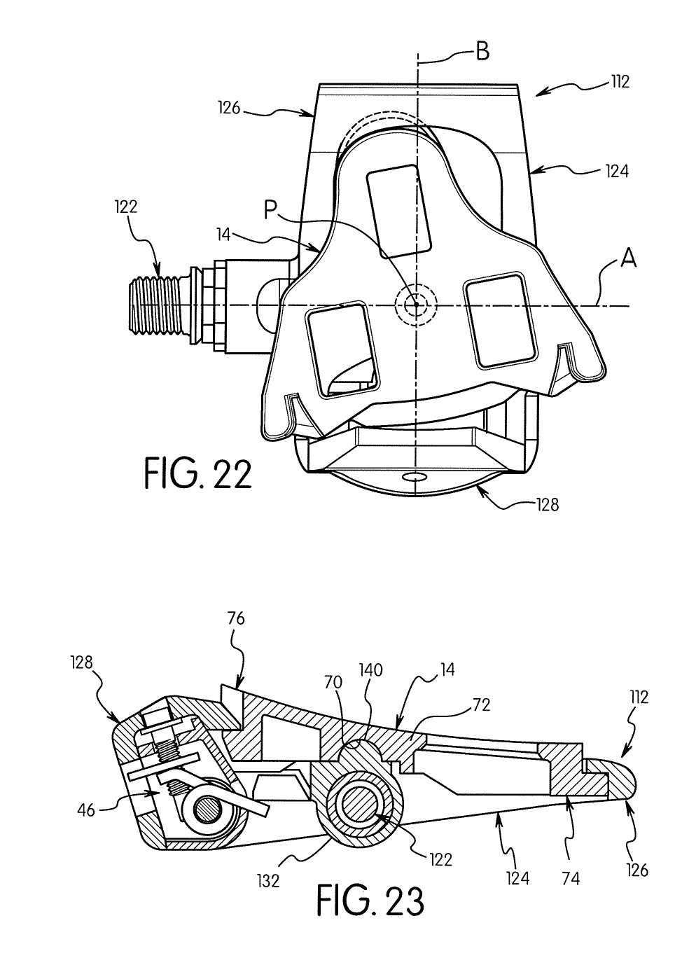

Referring to FIGS. 18 to 23, a bicycle pedal 112 is illustrated in accordance with a second embodiment. The bicycle pedal 112 has a spindle 122 and a modified pedal body 124. The pedal body 124 includes a front cleat engagement member 126, a rear cleat engagement member 128 and a center tubular shaft support portion 132 that has a pivot structure 140. The bicycle pedals 12 and 112 are identical, except that the pedal body 124 of the bicycle pedal 112 has been modified. In particular, the pedal body 124 has been modified such that front cleat clamping member 126 is not open at its lateral sides. Moreover, the shape of the pedal body 124 has been modified. The rear cleat clamping member 128 is identical to the rear cleat clamping member 28, discussed above. In view of the similarities between the bicycle pedals 12 and 112, the bicycle pedal 112 will not be discussed in detail herein.

In this embodiment, the pedal body 124 is an A-shaped member with a first (front) closed end and a second (rear) open end. The front cleat engagement member 126 is integrally formed at the front end of the pedal body 124, while the rear cleat engagement member 128 is pivotally coupled to the rear end of the pedal body 124. The pedal body 124 has a pivot structure 140 that is located at along both the spindle axis A and the pedal body axis B. However, the pivot structure 140 can be shifted either in a rearward direction or a forward direction as needed and/or desired.

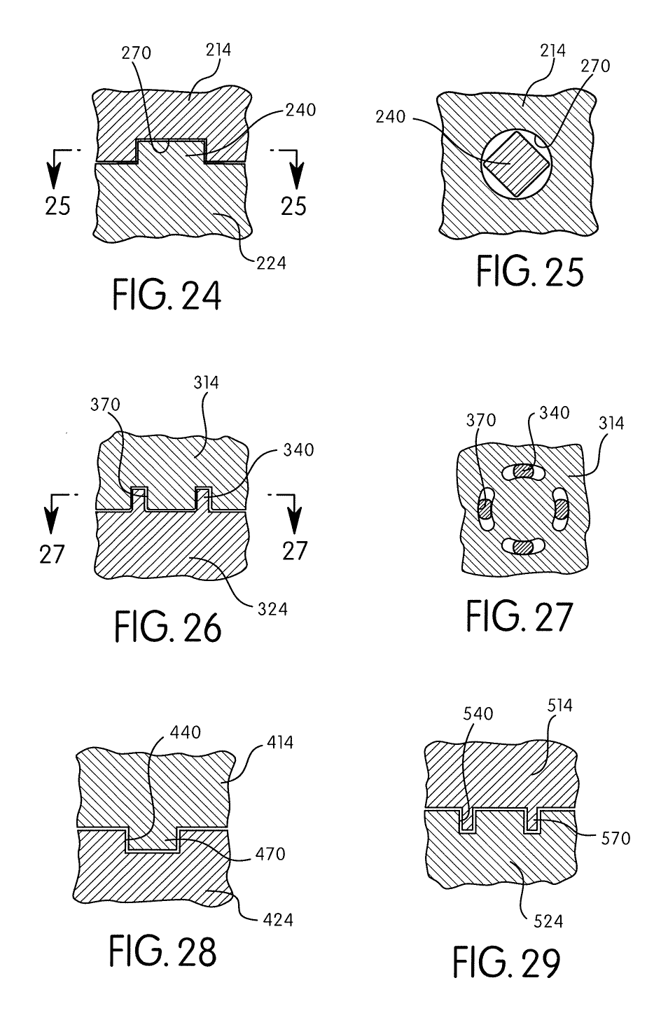

Referring to FIGS. 24 and 25, sectional views illustrate a pivot structure 240 (a first alternate configuration) for the above mentioned bicycle pedals 12, 12′, 12″ and 112. The pivot structure 240 is part of a pedal body 224 of any of the above mentioned bicycle pedals 12, 12′, 12″ and 112. The pivot structure 240 is used with a pivot structure 270 of a cleat 214, which is identical to the cleat 14 except for the pivot structure 270. The location of the pivot structure 270 on the cleat 214 is positioned to mate with the pivot structure 240 of the pedal body 224. The remaining structure of the pedal body 224 is identical to any one of the above mentioned bicycle pedals 12, 12′, 12″ and 112. Here, the pivot structure 240 has a polygon shape as viewed in a top plan view. Of course, a variety of other shapes are possible for the pivot structures of the above mentioned bicycle pedals 12, 12′, 12″ and 112 for used with the cleat 14 or 214.

Referring to FIGS. 26 and 27, sectional views illustrate a pivot structure 340 (a second alternate configuration) for the above mentioned bicycle pedals 12, 12′, 12″ and 112. The pivot structure 340 is part of a pedal body 324 of any of the above mentioned bicycle pedals 12, 12′, 12″ and 112. The pivot structure 340 is used with an alternate pivot structure 370 of a cleat 314, which is identical to the cleat 14 except for the pivot structure 370. Basically, the pivot structure 370 replaces the recess forming the pivot structure 70 in the cleat 14. The pivot structure 340 is used with the pivot structure 370, where the location of the pivot structure 370 is positioned to mate with the pivot structure 340 of the pedal body 324. The remaining structure of the pedal body 324 is identical to any one of the above mentioned bicycle pedals 12, 12′, 12″ and 112. Here, the pivot structure 340 includes a plurality of projections or pins, and the pivot structure 370 includes a plurality of recesses with each of the recesses receiving one of the pins of the pivot structure 340. Of course, a variety of other shapes are possible for these pivot structures 340 and 370. For example, the pivot structure 340 can be dimensioned to be used with the pivot structure 70 of the cleat 14.

Referring to FIG. 28, a cross sectional view is illustrated that shows a third alternate configuration of a pair of mating pivot structures 440 and 470. The pivot structure 440 can be used in the above mentioned bicycle pedals 12, 12′, 12″ and 112 as needed and/or desired by merely changing their pivot structures to this variation. Here, the pivot structure 440 includes a single recess on a pedal body 424, and the pivot structure 470 includes a single projection on a cleat 414, which is identical to the cleat 14 except for the pivot structure 470. This third alternate configuration of the mating pivot structures 440 and 470 is basically the same as that illustrated in FIGS. 24 and 25, but inverted. The remaining structure of the pedal body 424 is identical to any one of the above mentioned bicycle pedals 12, 12′, 12″ and 112. The remaining structure of the cleat 414 is identical to the above mentioned cleat 14 and/or its variations as mentioned above. Of course, a variety of other shapes are possible for these pivot structures 440 and 470. For example, the shapes of the pivot structures 440 and 470 can be half hemispheres.

Referring to FIG. 29, a cross sectional view is illustrated that shows a fourth alternate configuration of a pair of mating pivot structures 540 and 570. The pivot structure 540 can be used in the above mentioned bicycle pedals 12, 12′, 12″ and 112 as needed and/or desired by merely changing their pivot structures to this variation. Here, the pivot structure 540 includes a plurality of recesses on a pedal body 524, and the pivot structure 570 includes a plurality of projections on a cleat 514, which is identical to the cleat 14 except for the pivot structure 570. This fourth alternate configuration of the mating pivot structures 540 and 570 is basically the same as that illustrated in FIGS. 26 and 27, but inverted. The remaining structure of the pedal body 524 is identical to any one of the above mentioned bicycle pedals 12, 12′, 12″ and 112. The remaining structure of the cleat 514 is identical to the above mentioned cleat 14 and/or its variations as mentioned above. Of course, a variety of other shapes are possible for these pivot structures 540 and 570. For example, the pivot structure 570 can be dimensioned to be used with the pivot structure 440.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “member” or “element” when used in the singular refers to a single integrated part that moves as a unit and does not include a plurality of parts with independent and separate movement between. In other words, as used herein, the terms “member” or “element” can be made of several pieces to foam an integral unit, but does not include two or more parts with a first part that moves relative to a second part. As used herein to describe the present invention, the following directional terms “forward”, “rearward”, “above”, “downward”, “vertical”, “horizontal”, “below” “longitudinal” “lateral” and “transverse” as well as any other similar directional terms refer to those directions of a bicycle pedal mounted to a bicycle on a flat horizontal surface. Accordingly, these terms, as utilized to describe the present invention should be interpreted relative to a bicycle equipped with the bicycle pedal as used in the normal riding position on a flat horizontal surface. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Moreover, components that are shown directly connected or contacting each other can have intermediate structures disposed between them, unless otherwise indicated. The functions of one element can be performed by two, and vice versa. Thus, the foregoing descriptions of the embodiments of a bicycle pedal are provided for illustration only, and not for the purpose of limiting the invention as defined by the appended claims and their equivalents.

What is claimed is:

1. A bicycle pedal comprising:
a pedal spindle;
a pedal body rotatably mounted on the pedal spindle;
a first cleat engagement member disposed on the pedal body at a first location;
a second cleat engagement member disposed on the pedal body at a second location that is spaced from the first location,
at least one of the first and second cleat engagement members being movably mounted relative to the pedal body between a release position and an engagement position; and
a pivot structure disposed on the pedal body at a third location that is disposed between the first and second locations of the first and second cleat engagement members.

2. The bicycle pedal according to claim 1, wherein
the pivot structure includes either a projection or a recess disposed at the third location.

3. The bicycle pedal according to claim 1, wherein
the pivot structure includes either a plurality of projections or a plurality of recesses disposed at the third location.

4. The bicycle pedal according to claim 1, wherein
the third location of the pivot structure is at a longitudinal midpoint between the first and second cleat engagement members.

5. The bicycle pedal according to claim 1, wherein
the third location of the pivot structure is between the first cleat engagement member and a longitudinal midpoint between the first and second cleat engagement members.

6. The bicycle pedal according to claim 1, wherein
the third location of the pivot structure is between the second cleat engagement member and a longitudinal midpoint between the first and second cleat engagement members.

7. The bicycle pedal according to claim 1, wherein
the pedal spindle has a pedal spindle axis, and
the first and second cleat engagement members are longitudinally spaced from the third location with respect to a longitudinal axis of the pedal body that is transverse to the pedal spindle axis.

8. The bicycle pedal according to claim 1, wherein
the third location of the pivot structure is on a part of the pedal body which is adjacent the pedal spindle.

9. The bicycle pedal according to claim 1, wherein
the third location of the pivot structure is on a part of the pedal body which covers the pedal spindle.

10. The bicycle pedal according to claim 1, wherein
the third location of the pivot structure is adjacent a lateral midpoint of the pedal body with respect to a lateral direction of the pedal body.

11. The bicycle pedal according to claim 1, wherein
the first and second cleat engagement members are configured and arranged with respect to each other and the pivot structure to limit pivotally movement of a cleat that is retained on the pedal body.

12. The bicycle pedal according to claim 1, wherein
the first engagement member and the pedal body are integrally formed as a unitary, one-piece element.

13. The bicycle pedal according to claim 1, wherein
the second engagement member is pivotally coupled to the pedal body.

14. A bicycle pedal system comprising:
a cleat including
a first engagement end;
a second engagement end spaced from the first engagement end, and
a middle portion disposed between the first and second cleat engagement ends, the middle portion includes a first pivot structure; and
a pedal including
a pedal spindle,
a pedal body rotatably mounted on the pedal spindle,
a first cleat engagement member disposed on the pedal body at a first location,
a second cleat engagement member disposed on the pedal body at a second location that is spaced from the first location,
at least one of the first and second cleat engagement members being movably mounted relative to the pedal body between a release position and an engagement position, and
a second pivot structure disposed on the pedal body at a third location that is disposed between the first and second locations of the first and second cleat engagement members, the second pivot structure being configured to mate with the first pivot structure of the cleat.
